(19) United States
(12) Patent Application Publication
(10) Pub. No.: US 2025/0121631 A1
(43) Pub. Date: Apr. 17, 2025

(54) DEFORMABLE WHEEL WITH NON-PNEUMATIC LOAD BEARING AND A ROTARY STOP DISC FOR LUNAR AND MARTIAN CONDITIONS

(71) Applicant: VENTURI LAB SA, CORMINBOEUF (CH)

(72) Inventors: David OLSOMMER, CORMINBOEUF (CH); Gérard BAUMGARTNER, CORMINBOEUF (CH); Antonio DELFINO, CORMINBOEUF (CH)

(21) Appl. No.: 18/910,073

(22) Filed: Oct. 9, 2024

(30) Foreign Application Priority Data
Oct. 12, 2023 (EP) 23203183

(51) Int. Cl. B60C 7/14

(52) U.S. Cl. CPC B60C 7/146; B60C 2200/14

(57) ABSTRACT

A deformable wheel with non-pneumatic load bearing, intended to equip a vehicle for rolling under extreme conditions, such as those encountered on the Moon and on Mars may comprise a hub bearing at least one stop disc which projects radially towards the outside, a tread layer having an outer surface which is intended to be in contact with the ground being able to deform under an externally applied load in order to match the surface of the ground, and an inner surface which is able to come to bear against the stop disc in order to limit the deformations of the tread layer in the radial direction, and a plurality of radial reinforcements linking the tread layer to the hub.

### RELATED APPLICATIONS/PRIORITY CLAIMS

This application claims priority to EP Application Serial No. 23203183.1 filed on Oct. 12, 2023, the content of which is incorporated by reference herein.

### BACKGROUND

This application relates to a deformable wheel with non-pneumatic load bearing. More particularly, the application relates to a wheel which supports a load with its structural components and which has performance capabilities suitable for equipping a vehicle intended to roll under extreme conditions like those encountered on the Moon and on Mars.

The pneumatic wheel has load bearing, road-shock absorption and force transmission (accelerations, stops and changes of direction) capabilities, which are particularly well suited to many vehicles, in particular bicycles, motorcycles, automobiles and trucks. The shock absorbing capabilities of pneumatic tyres are also useful in other applications, for example for trolleys transporting medical equipment or sensitive electronic equipment.

Alternatives to the pneumatic wheel exist. These include solid tyres and spring tyres. However, these alternatives do not have the performance advantages of pneumatic wheels. In particular, solid tyres rely on compression of the part in contact with the ground, in order to support the load. This type of tyre can be heavy and rigid and does not have the shock absorption capacity of pneumatic wheels. When they are made more elastic, conventional non-pneumatic wheels do not have the load-support or endurance of pneumatic wheels.

In order to overcome these disadvantages, document U.S. Pat. No. 7,418,988 proposes a tyre with structural support which comprises an outer annular strip and a plurality of spokes extending transversely and radially inwards from the annular strip to the hub of the wheel, and intended to transmit load forces in tension between the annular strip and the hub.

The structurally supported wheel according to this application does not have a cavity intended to contain pressurised air and therefore does not need to have a seal with the rim of the wheel in order to maintain the internal air pressure. This structurally supported wheel does not therefore require a tyre in the sense that the word is understood.

The spokes of this wheel act in tension to transmit load forces between the wheel and the annular strip, which makes it possible in particular to support the mass of a vehicle. The support forces are generated by the tension of the spokes which are not connected to the part of the annular strip in contact with the ground. The spokes also transmit the forces required for acceleration, stopping and cornering.

Whatever the known alternatives of the prior art for producing non-pneumatic wheels, these are not generally entirely satisfactory, in particular when they are intended to roll under extreme conditions such as those encountered on the Moon and on Mars. More specifically, with such conditions, it is necessary that the wheel can deform significantly when passing over an obstacle, while generating a low uniform contact pressure in order to enable the vehicle to remain mobile on soft ground such as the ground encountered on the Moon and on Mars.

From patent application EP22192685, filed on 29 Aug. 2022 by the applicant, a wheel is known that can respond to these needs, in particular through the presence of a laminated annular strip which comprises a plurality of concentric ferrules which are assembled with the interposition of interposing layers, each composed of a material for which the Young's modulus is 600,000 to 1000 times less than that of the ferrules, for example made of elastomer material. Under an externally applied load, the portion of the laminated strip in contact with the ground deforms, not in an essentially circular shape but in a shape matching the surface of the ground, while maintaining an essentially constant length of the ferrules. The wheel according to this patent application can also generate a low and uniform contact pressure with the ground. In this way, the vehicle equipped with such wheels can remain mobile (i.e. does not get stuck in sand) even on soft ground (such as sand) as encountered on the Moon and on Mars.

The wheel described in this patent application also comprises solid discs of the hub which project radially outwards in order to form stops which can limit the movement of the tread layer of the wheel. More specifically, depending on the size of the obstacles over which the wheel passes, the inner surface of the laminated strip can abut against these discs carried by the hub, in order to limit the deformations undergone by the laminated strip.

Furthermore, depending on the use of the vehicle, it may be advantageous to be able to roll over short distances and at reduced speed while transporting loads, such that the inner surface of the laminated strip can permanently abut against the discs carried by the hub, even in the absence of an obstacle.

However, in these situations, due to the notable differences in tangential speed between the tread layer and the stop discs, the tread layer slides on the discs, which can damage the stops and significantly alter the inner surface of the tread layer. The integrity of the wheel is therefore threatened.

### Object and Summary of the Application

The main goal of the present application is therefore to overcome such disadvantages by proposing a deformable wheel structure with non-pneumatic load bearing, which includes a device which can avoid any alteration to the tread layer when it abuts with it.

According to the application, this goal is achieved through a deformable wheel with non-pneumatic load bearing, intended to equip a vehicle for rolling under extreme conditions such as those encountered on the Moon and on Mars, comprising:
a hub bearing at least one stop disc which projects radially outwards:
an annular tread layer positioned around the hub and having an outer surface which is intended to be in contact with the ground, being able to deform under an externally applied load in order to match the surface of the ground, and an inner surface which is able to come to bear against the stop disc in order to limit the deformation of the tread layer in the radial direction, and
a plurality of radial reinforcements linking the tread layer to the hub,
and wherein, according to the application, the stop disc is rotatably mounted on the hub in such a way as to be able to be rotated when the inner surface of the tread layer comes to bear against the stop disc.

The wheel according to the application is characterised in that the stop disc is rotatably mounted on the hub, which enables it to “roll” when the tread layer abuts against it despite the differences in speed. This system thus appears as a ball bearing type device which only comes into action when the tread layer comes into contact with the stop. Due to this possibility of rolling of the stop disc, the risk of alteration of the tread layer, and therefore of the wheel, are significantly reduced.

The stop disc is preferably mounted on an outer surface of the hub by means of a roller bearing.

In this case, the roller bearing can comprise a plurality of cylindrical rollers mounted between the outer surface of the hub and an inner annular strip of the stop disc.

The stop disc can comprise an outer annular strip which is mounted around the inner strip by means of a plurality of spring connections.

In this case, the spring connections can each be formed by a deformable ring.

The deformable ring of the spring connections is advantageously composed of windings of a stainless steel strip.

Preferably, each spring connection further comprises a bushing forming a rigid stop mounted inside the ring.

The cylindrical rollers are advantageously regularly distributed on the outer surface of the hub around an axis of rotation of the wheel.

Preferably, the outer strip of the stop disc is covered with a outer protection made of leather.

The hub can bear two stop discs spaced apart from one another along an axis of rotation of the wheel.

The tread layer can be a metal shear strip comprising a metal core provided with corrugations sandwiched between a ferrule and a plurality of circumferential springs giving the tread layer the ability to deform in flexion.

### BRIEF DESCRIPTION OF THE FIGURES

Other features and advantages will become apparent from the description given below, with reference to the appended drawings which illustrate an exemplary embodiment that is in no way limiting. In the figures:

FIG. 1 is a schematic face view of a wheel according to an embodiment;

FIG. 2 is a prospective cross-sectional view of the wheel of FIG. 1; and

FIG. 3 is a cross-sectional view of the wheel of FIG. 1.

### DETAILED DESCRIPTION OF THE EMBODIMENTS

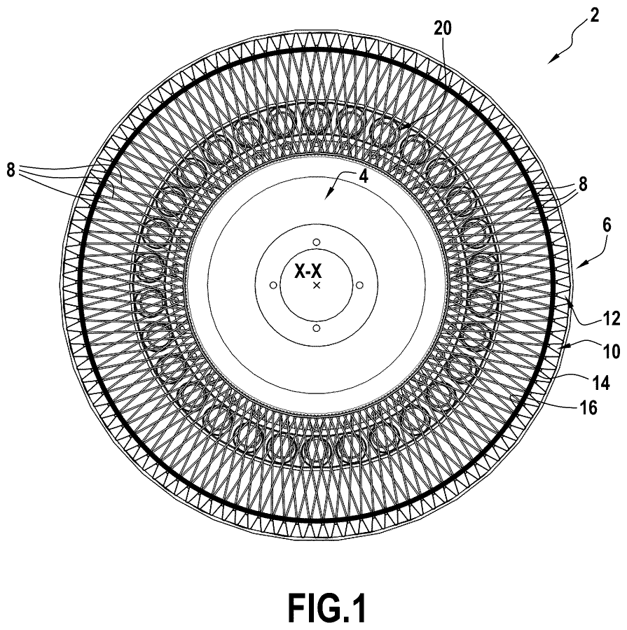

The application relates to a deformable wheel with non-pneumatic load bearing as shown in FIG. 1, which is suitable for equipping a vehicle intended to roll under extreme conditions such as those encountered on the Moon and on Mars.

The wheel 2 represented in FIG. 1 mainly comprises a hub 4, an annular tread layer 6 having an outer surface which is intended to be in contact with the ground, being able to deform under an externally applied load in order to match the surface of the ground, and a plurality of radial reinforcements (here metal cables 8) radially linking the hub to the tread layer.

In this embodiment, the tread layer 6 is a flexure strip which comprises a metal core 10 provided with a plurality of corrugations 12 sandwiched between a ferrule 14 and a plurality of circumferential springs 16 giving the tread layer the ability to deform in flexion.

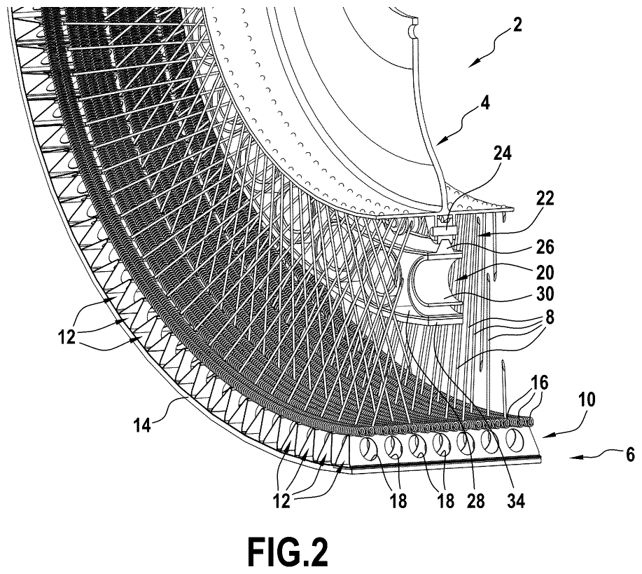

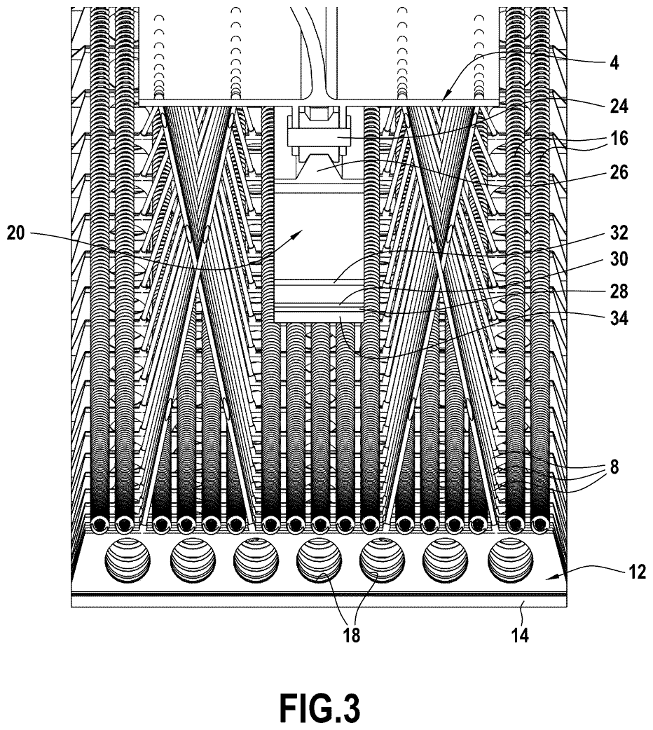

More precisely, as shown in FIGS. 2 and 3, the corrugations 12 of the core 10 of the tread layer are formed from metal sheets which are folded into V-shapes in the longitudinal direction (in other words parallel to the longitudinal axis of rotation X-X of the wheel 2).

It will be noted that the tip of the V-shapes of the metal sheet which form the corrugations 12 is pointing towards the inside of the wheel (in other words towards the axis of rotation X-X thereof) and opens out towards the outside of the 5 wheel.

It will also be noted that each correlation 12 of the core of the tread layer is symmetric with respect to a plane P radial to the wheel (and passing through the tip of the V-shape of the corrugation).

It will also be noted that the metal sheets which compose the corrugations advantageously have holes 18 which are distributed over their entire length in order to reduce the weight of the wheel.

The ferrule 14 of the tread layer 6 of the wheel according to this embodiment is made of metal or of composite material (for example with glass fibres or carbon fibres).

Finally, the tread layer 6 of the wheel according to this embodiment comprises a plurality of circumferential springs 16 giving the tread layer the ability to deform in flexion.

As previously indicated, in this embodiment, the radial reinforcements radially linking the hub 4 of the wheel to the tread layer 6 are composed of metal cables 8.

It will also be noted that in place of metal cables, the radial reinforcements radially linking the hub 4 of the wheel to the tread layer 6 can be composed of springs (this embodiment is not shown in the figures).

Similarly, in another embodiment (not shown in the figures), the tread layer is a laminated annular strip comprising a plurality of concentric ferrules which are assembled with interposition of interposing layers, each composed of a material for which Young's modulus is 600,000 to 1000 times less than that of the ferrules.

The ferrules of such a laminated strip can be made of metal or of a composite material, while the interposing layers can be composed of a hyperelastic elastomer having a glass transition temperature below 120° C.

Reference can be made to patent application EP22192685 filed by the applicant on 29 Aug. 2022, which describes such a wheel architecture with laminated tread layer.

Whatever the embodiment, the hub 4 of the wheel bears at least one stop disc 20 which projects radially towards the outside of the wheel.

When the surface of the ground on which the wheel 2 is rolling presents a significant obstacle (for example a rock), the part of the tread layer 6 which is in contact with the ground deforms in order to match the profile of the obstacle. In such a situation, depending on the size of the obstacle, the inner surface of the tread layer can abut against the outside diameter of the stop disc 20 borne by the hub 4 in order to limit the deformations undergone by the tread layer. A similar situation is possible during low-speed rolling and under heavy overload.

The stop disc 20 may be rotatably mounted on the hub 4 in such a way as to be able to be rotated about the axis X-X of the wheel, when the inner surface of the tread layer 6 comes to bear against the stop disc.

More precisely, in the embodiment of FIGS. 1 to 3, the stop disc 20 is mounted on an outer surface of the hub 4 by means of a roller bearing 22.

This roller bearing 22 preferably comprises a plurality of cylindrical rollers 24 which are mounted between the outer surface of the hub 4 and an inner annular strip 26 of the stop disc. The cylindrical rollers 24 are regularly distributed all around the axis of rotation X-X of the wheel.

In this way, when the inner surface of the tread layer 6 abuts against the outside diameter of the stop disc 20 (in particular when the wheel rolls on a significant obstacle), it can roll around the hub and this despite the different speeds of rotation of the hub and the tread layer.

According to an advantageous provision, the stop disc 20 also comprises an outer annular strip 28 which is mounted around the inner strip 26 by means of a plurality of spring connections 30.

In the embodiment of FIGS. 1 to 3, the spring connections are each formed by a deformable ring 30, advantageously composed of a plurality of windings of a stainless-steel strip (for example twelve windings of a strip of thickness 0.15 mm). Alternatively, these rings can be made of composite materials of the glass fibre and resin type.

It will be noted that the deformable rings 30 are preferably regularly distributed around all of the axis of rotation X-X of the wheel.

According to another advantageous provision, each spring connection further comprises a bushing 32 forming a rigid stop which is mounted inside the ring 30.

This bushing 32 can be fixed on the inner strip side 26 of the stop disc or on the outer strip side 28 of the stop disc. it can prevent the deformable rings 30 from deforming too much in the case of strong deformation of the tread layer.

According to yet another advantageous provision, the outer strip 28 of the stop disc is covered with an outer protection 34, made of leather for example.

In another embodiment which is not shown, the hub of the wheel bears two stop discs, spaced apart from one another along the axis of rotation X-X of the wheel.

1. A deformable wheel with non-pneumatic load bearing intended to equip a vehicle for rolling under extreme conditions such as those encountered on the Moon and on Mars, comprising:
a hub bearing at least one stop disc which projects radially outwards;
an annular tread layer positioned around the hub and having an outer surface which is intended to be in contact with the ground, being able to deform under an externally applied load in order to match the surface of the ground, and an inner surface which is able to come to bear against the stop disc in order to limit the deformation of the tread layer in the radial direction; and
a plurality of radial reinforcements linking the tread layer to the hub;
wherein the stop disc is rotatably mounted on the hub in such a way as to be able to be rotated when the inner surface of the tread layer comes to bear against the stop disc.

2. The wheel according to claim 1, wherein the stop disc is mounted on an outer surface of the hub by a roller bearing.

3. The wheel according to claim 2, wherein the roller bearing comprises a plurality of cylindrical rollers mounted between the outer surface of the hub and an inner annular strip of the stop disc.

4. The wheel according to claim 3, wherein the stop disc comprises an outer annular strip which is mounted around the inner strip by a plurality of spring connections.

5. The wheel according to claim 4, wherein the spring connections are each formed by a deformable ring.

6. The wheel according to claim 5, wherein the deformable ring of the spring connections is composed of windings of a stainless-steel strip.

7. The wheel according to claim 5, wherein each spring connection further comprises a bushing forming a rigid stop mounted inside the ring.

8. The wheel according to claim 3, wherein the cylindrical rollers are regularly distributed on the outer surface of the hub around an axis of rotation (X-X) of the wheel.

9. The wheel according to any one of claim 4, wherein the outer annular strip of the stop disc is covered with an outer protection made of leather.

10. The wheel according to claim 1, wherein the hub bears two stop discs spaced apart from one another along an axis of rotation (X-X) of the wheel.

11. The wheel according to claim 1, wherein the tread layer is a metal shear strip comprising a metal core provided with corrugations sandwiched between a ferrule and a plurality of circumferential springs giving the tread layer the ability to deform in flexion.

12. A vehicle comprising:
at least one deformable wheel with non-pneumatic load bearing, wherein the at least one wheel comprises:
a hub bearing at least one stop disc which projects radially outwards;
an annular tread layer positioned around the hub and having an outer surface which is intended to be in contact with the ground, being able to deform under an externally applied load in order to match the surface of the ground, and an inner surface which is able to come to bear against the stop disc in order to limit the deformation of the tread layer in the radial direction; and
a plurality of radial reinforcements linking the tread layer to the hub;
wherein the stop disc is rotatably mounted on the hub in such a way as to be able to be rotated when the inner surface of the tread layer comes to bear against the stop disc.

13. A deformable wheel with non-pneumatic load bearing, the deformable wheel comprising:
a hub bearing at least one stop disc which projects radially outwards;
an annular tread layer positioned around the hub and having an outer surface which deforms under an externally applied load, and an inner surface which limits deformation of the tread layer; and
a plurality of radial reinforcements linking the tread layer to the hub;
wherein the stop disc is rotatably mounted on the hub.

14. The deformable wheel of claim 13, wherein the stop disc is rotatably mounted on the hub in such a way as to be able to be rotated when the inner surface of the tread layer comes to bear against the stop disc.

15. The deformable wheel of claim 13, wherein the outer surface is intended to be in contact with the ground.

16. The wheel according to claim 13, wherein the stop disc is mounted on an outer surface of the hub by a roller bearing.

17. The wheel according to claim 16, wherein the roller bearing comprises a plurality of cylindrical rollers mounted between the outer surface of the hub and an inner annular strip of the stop disc.

18. The wheel according to claim 17, wherein the stop disc comprises an outer annular strip which is mounted around the inner strip by way of a plurality of spring connections.

19. The wheel according to claim 18, wherein the spring connections are each formed by a deformable ring.

20. The wheel according to claim 19, wherein the deformable ring of the spring connections is composed of windings of a stainless-steel strip.
